(19) United States
(12) Patent Application Publication
(10) Pub. No.: US 2022/0343571 A1
(43) Pub. Date: Oct. 27, 2022

(54) INFORMATION PROCESSING SYSTEM, INFORMATION PROCESSING APPARATUS, AND METHOD OF PROCESSING INFORMATION

(71) Applicants: Mana AKAIKE, Tokyo (JP); Atsushi ITOH, Kanagawa (JP)

(72) Inventors: Mana AKAIKE, Tokyo (JP); Atsushi ITOH, Kanagawa (JP)

(73) Assignee: Ricoh Company, Ltd., Tokyo (JP)

(21) Appl. No.: 17/712,482

(22) Filed: Apr. 4, 2022

(30) Foreign Application Priority Data
Apr. 21, 2021 (JP) 2021-072150

(51) Int. Cl. G06T 11/60; G06V 30/413; G06V 10/774

(52) U.S. Cl. CPC G06T 11/60; G06V 30/413; G06V 10/774

(57) ABSTRACT

A system, apparatus, and method of information processing, each of which determines an additional component to be added to a material image drawn on a medium, determines an advertisement component according to the additional component, and adds the additional component and the advertisement component to the material image to generate a modified image.

### CROSS-REFERENCE TO RELATED APPLICATIONS

This patent application is based on and claims priority pursuant to 35 U.S.C. § 119(a) to Japanese Patent Application No. 2021-072150, filed on Apr. 21, 2021, in the Japan Patent Office, the entire disclosure of which is hereby incorporated by reference herein.

### BACKGROUND

### Technical Field

The present disclosure relates to an information processing system, an information processing apparatus, and a method of processing information.

### Description of the Related Art

Using the available system, for example, at an event venue, a picture drawn on a sheet of paper by an event participant is read as image data, a motion is imparted to an image of the drawn picture, and the image with the imparted motion is displayed on a display device within the event venue. In the system, picture images created by a plurality of event participants appear one after another in a display area to animate the picture images across the same display area. The system enables the event participants to further enjoy the venue and is also expected to attract customers, resulting in being used for sales promotion, for example.

In addition, a technique is conceivable for allowing the event participants to generate, after the event, based on image data obtained by reading the pictures drawn at the event venue, modified images such as sticker images with, for example, a web application by using the image data. At this time, since a modified image, which is used as a sticker image or the like, is noticeable to many users, inserting various advertisement images of companies into the modified image may achieve an advertisement effect.

However, in a technique in which a predetermined advertisement is included without consideration of the content of an additional component to be included when a modified image is created for read image data, the advertisement may become inconspicuous or, conversely, become too conspicuous.

### SUMMARY

An information processing system according to an aspect of the present disclosure includes circuitry that determines an additional component to be added to a material image drawn on a medium, determines an advertisement component according to the additional component, and adds the additional component and the advertisement component to the material image to generate a modified image.

An information processing apparatus according to an aspect of the present disclosure includes circuitry that determines an additional component to be added to a material image drawn on a medium, determines an advertisement component according to the additional component, and adds the additional component and the advertisement component to the material image to generate a modified image.

An information processing method according to an aspect of the present disclosure includes determining an additional component to be added to a material image drawn on a medium; determining an advertisement component according to the additional component; and adding the additional component and the advertisement component to the material image to generate a modified image.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example general arrangement of an information processing system according to one or more embodiments of the disclosure;

FIG. 2 is a diagram illustrating an example configuration of an image display system according to the one or more embodiments of the disclosure;

FIG. 3 is a block diagram illustrating an example hardware configuration of a display control apparatus according to the one or more embodiments of the disclosure;

FIG. 4 is a block diagram illustrating an example hardware configuration of a content providing server according to the one or more embodiments of the disclosure;

FIG. 5 is a block diagram illustrating an example hardware configuration of an information terminal according to the one or more embodiments of the disclosure;

FIG. 6 is a block diagram illustrating an example configuration of functional blocks of the display control apparatus according to the one or more embodiments of the disclosure;

FIG. 7 is a block diagram illustrating an example configuration of functional blocks of the content providing server according to the one or more embodiments of the disclosure;

FIG. 8 is a view illustrating an example of a message table according to the one or more embodiments of the disclosure;

FIG. 9 is a view illustrating an example of an advertisement component table according to the one or more embodiments of the disclosure;

FIG. 10 is a view illustrating an example of an advertisement component selection rule table according to the one or more embodiments of the disclosure;

FIGS. 11A and 11B are views illustrating an example of a sheet for freehand drawing, which is used in the image display system according to the one or more embodiments of the disclosure;

FIG. 12 is a view illustrating an example of a picture drawn on the sheet for freehand drawing, which is used in the image display system according to the one or more embodiments of the disclosure;

FIG. 13 is a sequence diagram illustrating an example process for registering, in the content providing server, a material image acquired by the display control apparatus in the information processing system according to the one or more embodiments of the disclosure;

FIG. 14 is a flowchart illustrating an example modified-image generation process performed by the content providing server according to the one or more embodiments of the disclosure;

FIGS. 15A and 15B are views illustrating an example of the material image and a title image, respectively, according to the one or more embodiments of the disclosure;

FIG. 16 is a view illustrating an example of a top screen for selecting a material image according to the one or more embodiments of the disclosure;

FIG. 17 is a view illustrating an example of a material display screen according to the one or more embodiments of the disclosure;

FIG. 18 is a view illustrating an example of selection of a message on a message selection screen according to the one or more embodiments of the disclosure;

FIG. 19 is a view illustrating an example of a message selection screen on which a motion is selectable according to the one or more embodiments of the disclosure;

FIG. 20 is a view illustrating an example of results of an association between a material image and a message according to the one or more embodiments of the disclosure;

FIG. 21 is a view illustrating an example of a determined advertisement component according to the one or more embodiments of the disclosure;

FIG. 22 is a view illustrating another example of selection of a message on the message selection screen according to the one or more embodiments of the disclosure;

FIG. 23 is a view illustrating another example of results of an association between a material image and a message according to the one or more embodiments of the disclosure;

FIG. 24 is a view illustrating another example of a determined advertisement component according to the one or more embodiments of the disclosure;

FIG. 25 is a view illustrating an example of a modified-image completion screen according to the one or more embodiments of the disclosure;

FIG. 26 is a view illustrating another example of the modified-image completion screen according to the one or more embodiments of the disclosure; and

FIG. 27 is a view illustrating an example of a picture drawn on a sheet for freehand drawing, which is used in an image display system according to a modification.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result. Referring now to the drawings, embodiments of the present disclosure are described below. As used herein, the singular forms “a,” “an,” and “the” are intended to include the plural forms as well, unless the context clearly indicates otherwise.

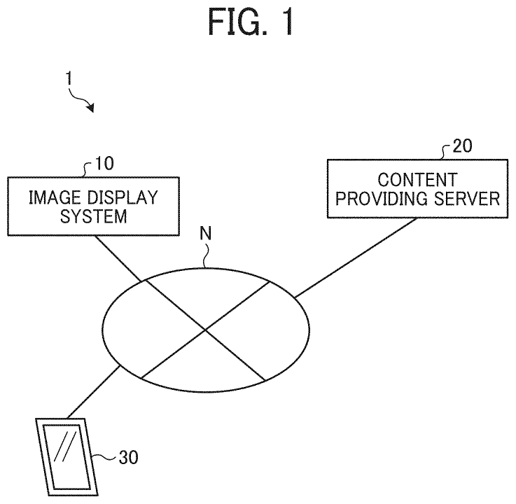

An information processing system, an information processing apparatus, an information processing method, and a program according to embodiments of the present disclosure will be described in detail hereinafter with reference to the FIGS. 1 to 27. The present disclosure, however, is not limited to the following embodiments, and the constituent elements of the following embodiments include those that can be easily conceived by those skilled in the art, those being substantially the same ones, and those being within equivalent ranges. Furthermore, various omissions, substitutions, changes, and combinations of the constituent elements can be made without departing from the gist of the following embodiments.

### General Arrangement of Information Processing System

FIG. 1 is a diagram illustrating an example general arrangement of an information processing system according to an embodiment of the disclosure. A general arrangement of an information processing system 1 according to this embodiment will be described with reference to FIG. 1.

The information processing system 1 illustrated in FIG. 1 is a system for registering image data read by an image display system 10 in a content providing server 20 and generating a modified image from the image data registered in the content providing server 20 in response to an operation performed on an information terminal 30. As illustrated in FIG. 1, the information processing system 1 includes the image display system 10, the content providing server 20, and the information terminal 30. The image display system 10, the content providing server 20, and the information terminal 30 are capable of data communication via a network N.

The network N is a network constituted by at least one of a local area network (LAN), a virtual private network (VPN), or the Internet. The network N enables data communication among, other than the apparatuses and system described above, an application providing server, an external service providing server, a social networking service (SNS) server, and other servers, as appropriate.

The image display system 10 is a system installed in, for example, an event venue and configured such that a sheet having a picture drawn by an event participant is read by, for example, event staff (or an operator) using an image reading apparatus to produce image data and the image data is projected using a projector for display.

The content providing server 20 is a server that registers the image data read by the image display system 10 and provides the image data to the information terminal 30 as content.

The information terminal 30 is an information processing apparatus, such as a smartphone, a tablet terminal, or a personal computer (PC), to which a service for modifying image data is provided from the content providing server 20.

### Configuration of Image Display System

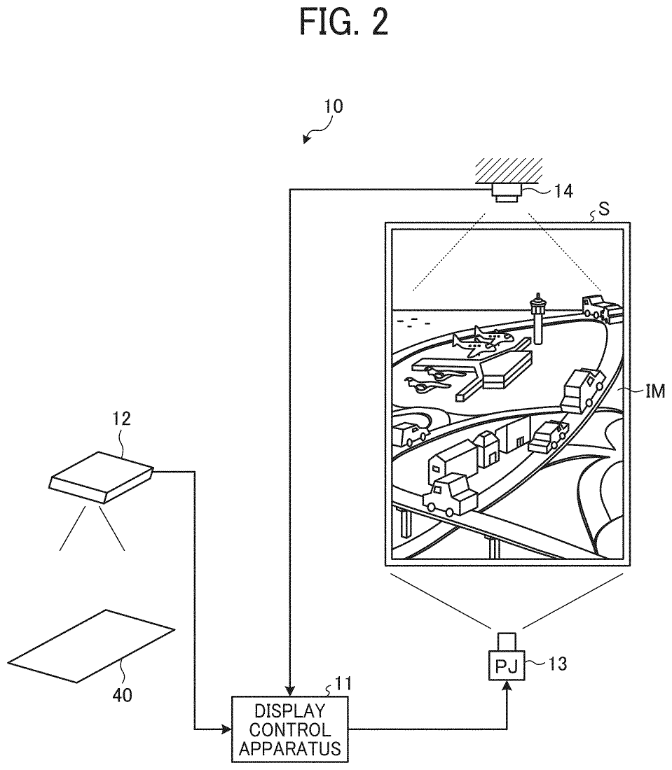

FIG. 2 is a diagram illustrating an example configuration of an image display system according to an embodiment of the disclosure. A configuration of the image display system 10 according to this embodiment will be described with reference to FIG. 2.

As illustrated in FIG. 2, the image display system 10 includes a display control apparatus 11, an image reading apparatus 12, a projector 13, and an area measurement sensor 14.

The display control apparatus 11 is an information processing apparatus such as a PC or a workstation that performs predetermined image processing on image data of a picture drawn by a participant at an event venue or the like, the image data being obtained by reading a sheet 40 with the image reading apparatus 12, to acquire a read image. The display control apparatus 11 transmits a projection image including a user object described below, which is generated based on the read image, to the projector 13. The display control apparatus 11 further transmits a material image and a title image to the content providing server 20 at a predetermined timing. The material image is extracted from the read image, and the title image indicates the title or caption of the picture. The display control apparatus 11 may be constituted by, instead of a single information processing apparatus, a plurality of information processing apparatuses.

The image reading apparatus 12 is an apparatus that reads the sheet 40 on which the picture is drawn by the event participant by hand to obtain image data and transmits the image data to the display control apparatus 11. The image reading apparatus 12 includes, for example, a scanner (or an imaging device), a mounting table on which the sheet 40 is mountable, and a jig for securing the scanner to the mounting table at a predetermined height. The sheet 40 is placed face up on the mounting table, and the front side of the sheet 40 is optically scanned with the scanner to read an image on the front side of the sheet 40.

The projector 13 is an apparatus that projects the projection image received from the display control apparatus 11 onto a screen S serving as a display medium as a projection image IM.

The area measurement sensor 14 is a sensor that detects an object such as the participant's hand at a position in front of the screen S and transmits position information of the detected object to the display control apparatus 11. For example, as illustrated in FIG. 2, the area measurement sensor 14 is installed on the ceiling above the screen S. The display control apparatus 11 associates the position information of the object such as the participant's hand, which is received from the area measurement sensor 14, with a position on the projection image IM projected onto the screen S, identifies the position on the projection image IM pointed to by the participant, and executes predetermined event processing such as changing the projection image IM. The action of pointing to a specific position on the projection image IM by a participant may be referred to as “touch”. Further, touching the projection image IM by the participant may include directly contacting the screen S if the position of the touch is detectable by the area measurement sensor 14. As described above, the image display system 10 is capable of providing an interactive environment such that predetermined event processing is executed in response to a touch operation of a participant.

Examples of the medium having a picture and a title of the picture include the sheet 40, and an information processing terminal, such as a tablet terminal, including a display device and an input device that are integrated into a single device such that coordinate information can be input in accordance with a designated position provided by a participant to the input device. The information processing terminal is capable of displaying a three-dimensional object on a screen displayed on the display device. The participant operates the input device to draw a picture while rotating a three-dimensional object displayed on the screen of the information processing terminal to directly draw the three-dimensional object. The information processing terminal transmits image data of the drawn three-dimensional object to the display control apparatus 11.

### Hardware Configuration of Display Control Apparatus

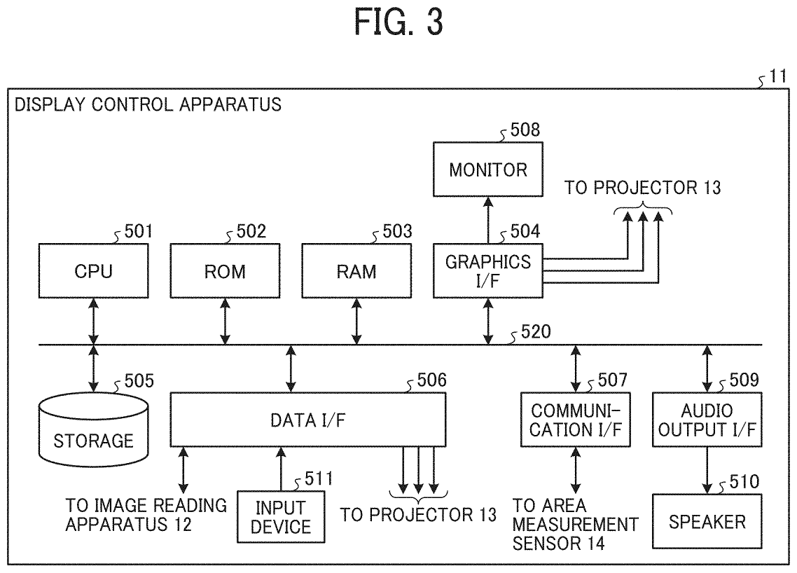

FIG. 3 is a block diagram illustrating an example hardware configuration of a display control apparatus according to an embodiment of the disclosure. A hardware configuration of the display control apparatus 11 according to this embodiment will be described with reference to FIG. 3.

As illustrated in FIG. 3, the display control apparatus 11 includes a central processing unit (CPU) 501, a read only memory (ROM) 502, a random access memory (RAM) 503, a graphics interface (I/F) 504, a storage 505, a data I/F 506, a communication I/F 507, a monitor 508, an audio output I/F 509, a speaker 510, and an input device 511.

The CPU 501 is an arithmetic processor that controls the overall operation of the display control apparatus 11. The ROM 502 is a non-volatile storage device that stores a basic input/output system (BIOS) for the display control apparatus 11, programs, and the like. The RAM 503 is a volatile storage device used as a work area for the CPU 501.

The graphics I/F 504 is an interface for transmitting image data used for displaying an image on the monitor 508 and projecting the image with the projector 13.

The storage 505 is an auxiliary storage device that stores various image data such as a read image, a material image, and a title image, various programs, and the like. Examples of the auxiliary storage device include a hard disk drive (HDD), a solid state drive (SSD), and a flash memory.

The data I/F 506 is an interface for establishing data communication with the image reading apparatus 12 and the projector 13 and for receiving operation information from the input device 511. For example, the data I/F 506 transmits a control signal generated by the CPU 501 to the image reading apparatus 12 and the projector 13. The data I/F 506 is, for example, a universal serial bus (USB) interface.

The communication I/F 507 is an interface for connecting to a network or the like to establish data communication. In the example illustrated in FIG. 3, the communication I/F 507 is connected to the area measurement sensor 14, and receives position information of an object detected by the area measurement sensor 14. The communication I/F 507 is also connected to the network N illustrated in FIG. 1. As one example, the communication I/F 507 is a network interface card (NIC) capable of establishing communication using a protocol such as transmission control protocol/Internet protocol (TCP/IP). The area measurement sensor 14 may be connected to the data I/F 506 instead of being connected to the communication I/F 507.

The monitor 508 is a display device that displays various types of information including a cursor, a menu, a window, text, and an image, or a screen of an application to be executed by the CPU 501. Examples of the monitor 508 include a liquid crystal display and an organic electroluminescent (EL) display. The monitor 508 is connected to the graphics I/F 504 via, for example, a video graphics array (VGA) cable, a High-Definition Multimedia Interface (HDMI) (registered trademark) cable, or the like.

The audio output I/F 509 is an interface for outputting audio data to the speaker 510. The speaker 510 is a device that outputs sound based on the audio data received according to the operation of the application executed by the CPU 501.

The input device 511 includes a keyboard and a mouse, each of which is operated by a user to select a character, a number, or an instruction, move a cursor being displayed, and set setting information, for example.

The CPU 501, the ROM 502, the RAM 503, the graphics I/F 504, the storage 505, the data I/F 506, the communication I/F 507, and the audio output I/F 509 described above are communicably connected to each other via a bus 520 such as an address bus and a data bus.

The hardware configuration of the display control apparatus 11 illustrated in FIG. 3 is an example. Not all of the components described above may be included in the display control apparatus 11, and the display control apparatus 11 may include any other component.

### Hardware Configuration of Content Providing Server

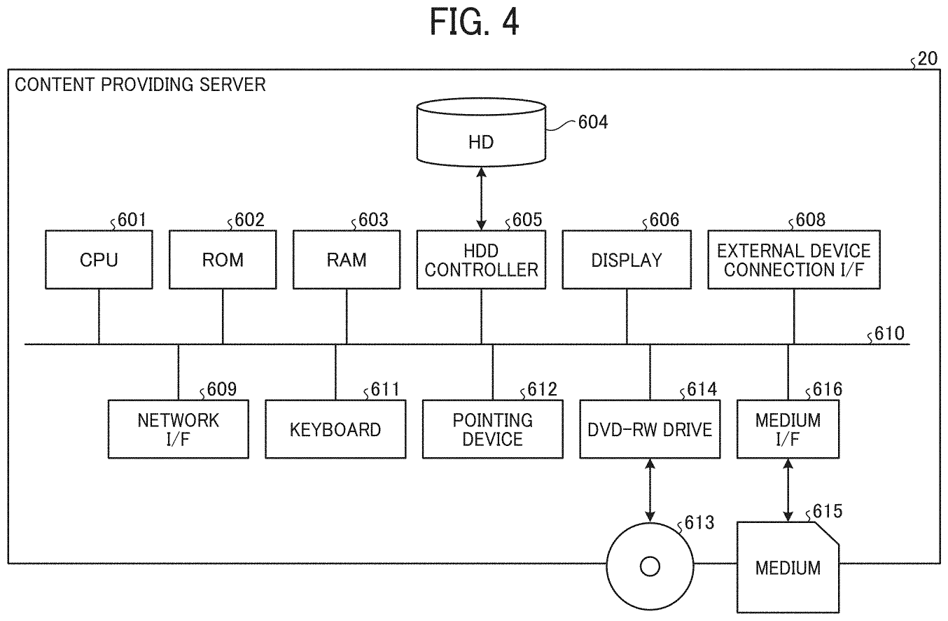

FIG. 4 is a block diagram illustrating an example hardware configuration of a content providing server according to an embodiment of the disclosure. A hardware configuration of the content providing server 20 according to this embodiment will be described with reference to FIG. 4.

As illustrated in FIG. 4, the content providing servers 20 includes a CPU 601, a ROM 602, a RAM 603, an HD 604, an HDD controller 605, a display 606, an external device connection I/F 608, a network I/F 609, a keyboard 611, a pointing device 612, a digital versatile disc rewritable (DVD-RW) drive 614, and a medium I/F 616.

The CPU 601 is an arithmetic processor that controls the overall operation of the content providing server 20. The ROM 602 is a non-volatile storage device that stores a program used to drive the CPU 601, such as an initial program loader (IPL). The RAM 603 is a volatile storage device used as a work area for the CPU 601.

The HD 604 is an auxiliary storage device that stores various data such as a program. The HDD controller 605 is a controller that controls reading or writing of various data from or to the HD 604 under the control of the CPU 601.

The display 606 is a liquid crystal display, an organic EL display, or the like that displays various types of information such as a cursor, a menu, a window, text, or an image.

The external device connection I/F 608 is an interface for connecting to various external devices. The external devices include, for example, but are not limited to, a USB memory and a printer.

The network I/F 609 is an interface for establishing data communication using the network N. As one example, the network I/F 609 is an NIC capable of establishing communication using a protocol such as TCP/IP.

The keyboard 611 is one example of an input device provided with a plurality of keys for inputting characters, numerical values, various instructions, or the like. The pointing device 612 is a type of input device operated by a user to select or execute various instructions, select a target for processing, and move a cursor being displayed, for example.

The DVD-RW drive 614 controls reading or writing of various data from or to a DVD 613, which is an example of a removable recording medium. Examples of the DVD 613 include a DVD-RW, a digital versatile disc recordable (DVD-R), a compact disc rewritable (CD-RW), and a compact disc recordable (CD-R).

The medium I/F 616 is an interface that controls reading or writing of data from or to a medium 615 such as a flash memory.

The CPU 601, the ROM 602, the RAM 603, the HDD controller 605, the display 606, the external device connection I/F 608, the network I/F 609, the keyboard 611, the pointing device 612, the DVD-RW drive 614, and the medium I/F 616 described above are communicably connected to each other via a bus 610 such as an address bus and a data bus.

The hardware configuration of the content providing server 20 illustrated in FIG. 4 is an example. Not all of the components described above may be included in the content providing server 20, and the content providing server 20 may include any other component.

The content providing server 20 may not be constituted by a single information processing apparatus such as a server, but may be constituted by a plurality of information processing apparatuses as an information processing system.

### Hardware Configuration of Information Terminal

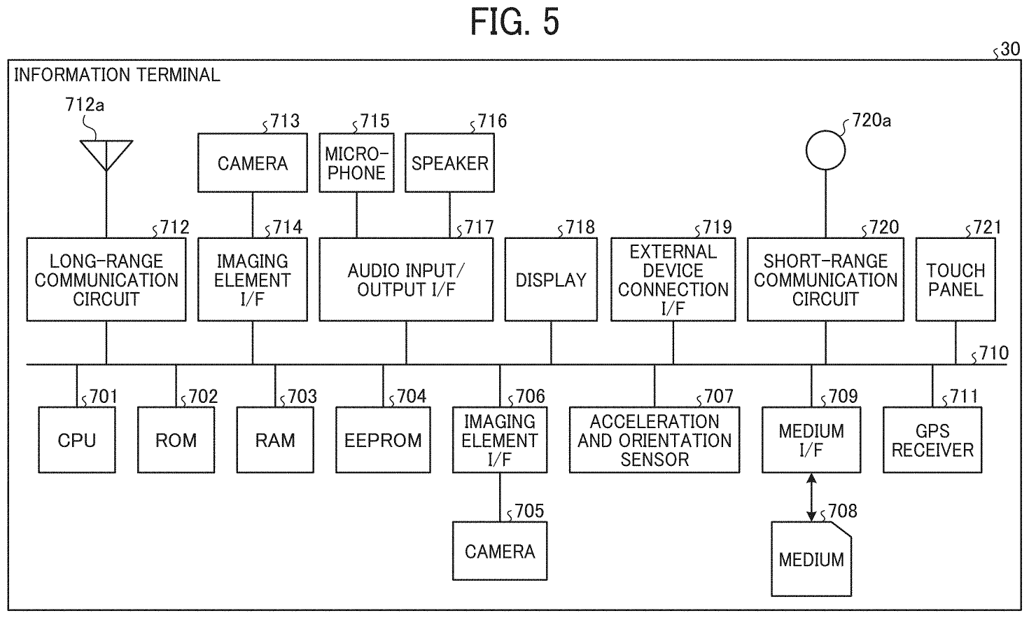

FIG. 5 is a block diagram illustrating an example hardware configuration of an information terminal according to an embodiment of the disclosure. A hardware configuration of the information terminal 30 according to this embodiment will be described with reference to FIG. 5.

As illustrated in FIG. 5, the information terminal 30 includes a CPU 701, a ROM 702, a RAM 703, an electrically erasable programmable read only memory (EEPROM) 704, a camera 705, an imaging element I/F 706, an acceleration and orientation sensor 707, a medium I/F 709, and a Global Positioning System (GPS) receiver 711.

The CPU 701 is an arithmetic processor that controls the overall operation of the information terminal 30. The ROM 702 is a non-volatile storage device that stores a program used to drive the CPU 701, such as an IPL. The RAM 703 is a volatile storage device used as a work area for the CPU 701. The EEPROM 704 is a non-volatile storage device that stores a program such as a web browser and various data under the control of the CPU 701.

The camera 705 is a built-in imaging device that captures an image of an object using a complementary metal oxide semiconductor (CMOS) image sensor to obtain image data under the control of the CPU 701. The camera 705 may include, instead of a CMOS image sensor, a charge coupled device (CCD) image sensor or any other image sensor. The imaging element I/F 706 is an interface for controlling the driving of the camera 705.

The acceleration and orientation sensor 707 includes various sensors such as an electromagnetic compass or gyrocompass for detecting geomagnetism and an acceleration sensor.

The medium I/F 709 is an interface that controls reading or writing of data from or to a medium 708 such as a flash memory.

The GPS receiver 711 is a receiving device that receives a GPS signal from a GPS satellite.

As illustrated in FIG. 5, the information terminal 30 further includes a long-range communication circuit 712, an antenna 712a, a camera 713, an imaging element I/F 714, a microphone 715, a speaker 716, an audio input/output I/F 717, a display 718, an external device connection I/F 719, a short-range communication circuit 720, an antenna 720a, and a touch panel 721.

The long-range communication circuit 712 is a circuit that wirelessly communicates with another device via the network N using the antenna 712a.

The camera 713 is a built-in imaging device that captures an image of an object using a CMOS image sensor to obtain image data under the control of the CPU 701. The camera 713 may include, instead of a CMOS image sensor, a CCD image sensor or any other image sensor. The imaging element I/F 714 is an interface for controlling the driving of the camera 713.

The microphone 715 is a built-in sound collector that converts sound into electrical signals. The speaker 716 is a built-in circuit that converts electrical signals into physical vibrations and outputs sound such as music or voice. The audio input/output I/F 717 is an interface that processes input and output of an audio signal between the microphone 715 and the speaker 716 under the control of the CPU 701.

The display 718 is a liquid crystal display, an organic EL display, or the like that displays an image of an object, various icons, and the like. The external device connection I/F 719 is an interface for connecting to various external devices. The short-range communication circuit 720 is a communication circuit in compliance with near field communication (NFC), Bluetooth (registered trademark), or any other suitable standard using the antenna 720a.

The touch panel 721 is an input device that allows a user to touch the display 718 to operate the information terminal 30.

The CPU 701, the ROM 702, the RAM 703, the EEPROM 704, the imaging element I/F 706, the acceleration and orientation sensor 707, the medium I/F 709, the GPS receiver 711, the long-range communication circuit 712, the imaging element I/F 714, the audio input/output I/F 717, the display 718, the external device connection I/F 719, the short-range communication circuit 720, and the touch panel 721 described above are communicably connected to each other via a bus 710 such as an address bus and a data bus.

The hardware configuration of the information terminal 30 illustrated in FIG. 5 is an example. Not all of the components described above may be included in the information terminal 30, and the information terminal 30 may include any other component.

### Configuration and Operation of Functional Blocks of Display Control Apparatus

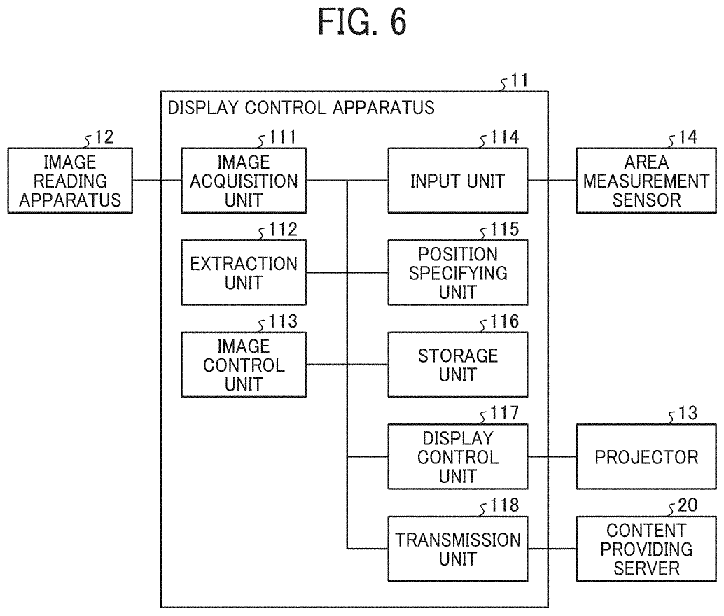

FIG. 6 is a block diagram illustrating an example configuration of functional blocks of a display control apparatus according to an embodiment of the disclosure. A configuration and operation of functional blocks of the display control apparatus 11 according to this embodiment will be described with reference to FIG. 6.

As illustrated in FIG. 6, the display control apparatus 11 includes an image acquisition unit 111, an extraction unit 112, an image control unit 113, an input unit 114, a position specifying unit 115, a storage unit 116, a display control unit 117, and a transmission unit 118.

The image acquisition unit 111 is a functional unit that acquires a read image read from the sheet 40 by the image reading apparatus 12. The image acquisition unit 111 stores the acquired read image in the storage unit 116. The image acquisition unit 111 is implemented through execution of a program by the CPU 501 illustrated in FIG. 3, for example.

The extraction unit 112 is a functional unit that extracts, from the read image acquired by the image acquisition unit 111, a material image corresponding to a picture drawn in a drawing area of the sheet 40, which will be described below, and a title image corresponding to a title written in a title area. The extraction unit 112 stores the extracted material image and title image in the storage unit 116. The extraction unit 112 is implemented through execution of a program by the CPU 501 illustrated in FIG. 3, for example.

The image control unit 113 is a functional unit that performs operation control on a three-dimensional object based on the material image extracted by the extraction unit 112. The image control unit 113 is implemented through execution of a program by the CPU 501 illustrated in FIG. 3, for example.

The input unit 114 is a functional unit that receives input of operation information from the input device 511 and information on a position at which a touch operation is detected by the area measurement sensor 14. The input unit 114 is implemented by the data I/F 506 and the communication I/F 507 and through execution of a program by the CPU 501 illustrated in FIG. 3.

The position specifying unit 115 is a functional unit that specifies a position on the projection image IM pointed to by a participant in the event with their hand from a correspondence between position information of the hand of the participant, which is input from the area measurement sensor 14 via the input unit 114, and the corresponding position on the projection image IM. The position specifying unit 115 is implemented through execution of a program by the CPU 501 illustrated in FIG. 3, for example.

The storage unit 116 is a functional unit that stores various image data such as a read image, a material image, and a title image, various programs, and the like. The storage unit 116 is implemented by the storage 505 illustrated in FIG. 3.

The display control unit 117 is a functional unit that controls the projection operation of the projector 13 and the display operation of the monitor 508. Specifically, the display control unit 117 transmits two-dimensional image data in a three-dimensional image data space to the projector 13 as a projection image for display. The display control unit 117 is implemented by the graphics I/F 504 and through execution of a program by the CPU 501 illustrated in FIG. 3.

The transmission unit 118 is a functional unit that transmits the material image and the title image extracted by the extraction unit 112 to the content providing server 20 at a predetermined timing. The transmission unit 118 is implemented by the communication I/F 507 and through execution of a program by the CPU 501 illustrated in FIG. 3.

The image acquisition unit 111, the extraction unit 112, the image control unit 113, the input unit 114, the position specifying unit 115, the display control unit 117, and the transmission unit 118 of the display control apparatus 11 illustrated in FIG. 6 may be implemented through execution of a program by the CPU 501 illustrated in FIG. 3, that is, by software, by hardware such as integrated circuits, or by a combination of software and hardware.

The functional units of the display control apparatus 11 illustrated in FIG. 6 are conceptually illustrated functions and are not limited to the illustrated components. For example, a plurality of functional units that are illustrated as independent functional units in FIG. 6 may be combined into one functional unit. Alternatively, a function of one of the functional units illustrated in FIG. 6 may be divided into a plurality of functions to form a plurality of functional units.

### Configuration and Operation of Functional Blocks of Content Providing Server

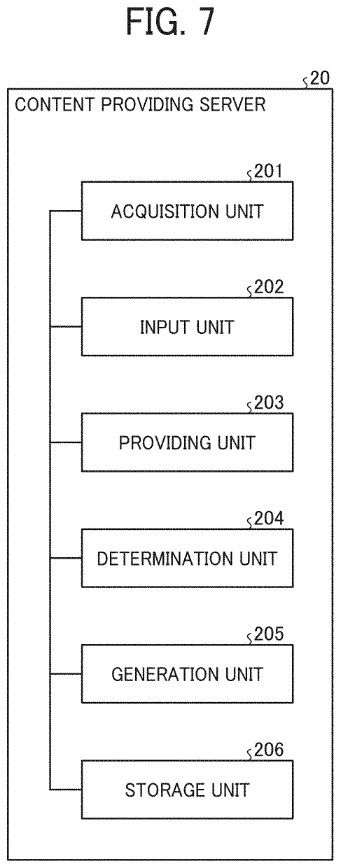

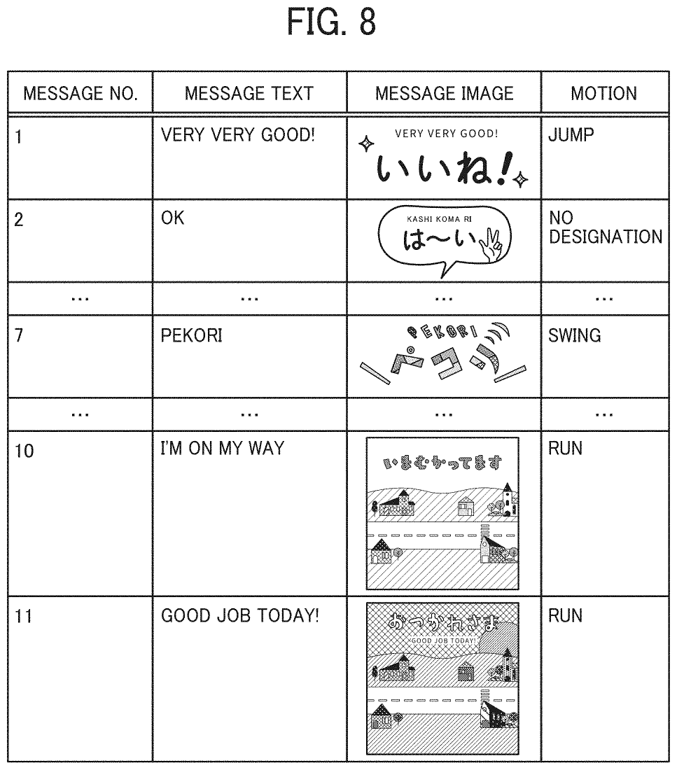

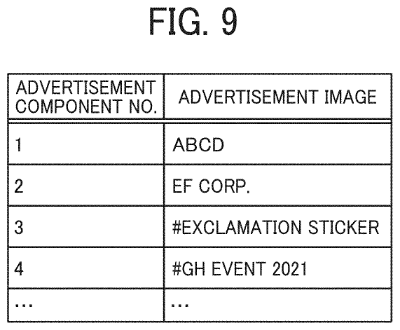

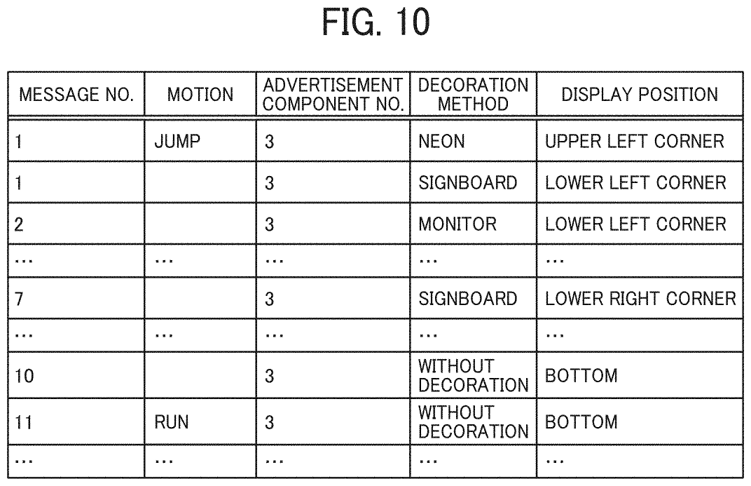

FIG. 7 is a block diagram illustrating an example configuration of functional blocks of a content providing server according to an embodiment of the disclosure. FIG. 8 is a view illustrating an example of a message table. FIG. 9 is a view illustrating an example of an advertisement component table. FIG. 10 is a view illustrating an example of an advertisement component selection rule table. A configuration and operation of functional blocks of the content providing server 20 according to this embodiment will be described with reference to FIGS. 7 to 10.

As illustrated in FIG. 7, the content providing server 20 includes an acquisition unit 201, an input unit 202, a providing unit 203, a determination unit 204, a generation unit 205, and a storage unit 206.

The acquisition unit 201 is a functional unit that acquires a material image and a title image, which are output from the display control apparatus 11 of the image display system 10, and registers the material image and the title image in the storage unit 206. The material image is an image of a picture drawn in the drawing area of the sheet 40, and the title image is an image of the title of the picture written in the title area. The acquisition unit 201 further acquires a predetermined material image and a predetermined title image from the storage unit 206 in accordance with an operation instruction from the information terminal 30. The acquisition unit 201 is implemented through execution of a program by the CPU 601 illustrated in FIG. 4, for example.

The input unit 202 is a functional unit that receives an input of information on an operation performed on the web browser executed by the information terminal 30. The input unit 202 is implemented through execution of a program such as a web application by the CPU 601 illustrated in FIG. 4, for example.

The providing unit 203 is a functional unit that provides various types of content to the information terminal 30. The various types of content include, for example, but are not limited to, a material image, a title image, an additional component, an advertisement component, and a modified image. The additional component and the advertisement component are used to modify the material image, and the modified image is obtained as a result of modifying the material image. Further, the providing unit 203 provides, to the information terminal 30, content that can be added to the material image, such as an additional component including, for example, a message and a motion, and an advertisement component. The various types of content are formed as web pages that are displayable on the information terminal 30 using the web browser. The providing unit 203 is implemented through execution of a program such as a web application by the CPU 601 illustrated in FIG. 4, for example.

The determination unit 204 is a functional unit that determines an additional component and an advertisement component to be added to the material image. The determination unit 204 is implemented in accordance with a program such as a web application executed by the CPU 601 illustrated in FIG. 4, for example.

The generation unit 205 is a functional unit that adds the additional component and the advertisement component determined by the determination unit 204 to the material image to generate a modified image. As described below, if the additional component includes a motion to be imparted to the material image, for example, the generation unit 205 generates a modified image as a Graphics Interchange Format (GIF) animation. If the additional component does not include a motion to be imparted to the material image, the generation unit 205 generates a modified image as a still image. The generation unit 205 is implemented through execution of a program such as a web application by the CPU 601 illustrated in FIG. 4, for example.

The storage unit 206 is a functional unit that stores the material image and the title image acquired by the acquisition unit 201, the modified image generated by the generation unit 205, and various tables. The various tables are used by the determination unit 204 to determine an additional component and an advertisement component. The storage unit 206 is implemented by the HD 604 illustrated in FIG. 4.

The storage unit 206 stores a message table illustrated in FIG. 8. The message table is a table for managing additional components to be addable to material images. Specifically, the message table manages a message number, a message text, a message image, and a motion in association with each other. As used herein, the term “additional component” is used to indicate a message and a motion. The term “message” is used to indicate a message text and a message image.

The message number is an example of identification information uniquely identifying an additional component, such as an identification number. The message text is a text portion included in a message. Some messages may include no text portion. The message image is an image portion included in the message. The message image may be a moving image. The motion indicates a type of motion to be imparted to a material image.

The message table illustrated in FIG. 8 includes motions, non-limiting examples of which include “jump”, “no designation”, “swing”, and “run”. Other motions such as “zoom” (enlarging or shrinking) and “stand still” may be included. When “no designation” is selected, for example, a motion may be randomly determined.

The additional components may further include sounds. In this case, the message table may further manage a sound in association with a message number, a message text, a message image, and a motion.

The storage unit 206 also stores an advertisement component table illustrated in FIG. 9. The advertisement component table is a table for managing advertisement images among advertisement components. Specifically, the advertisement component table manages an advertisement component number and an advertisement image in association with each other. As used herein, the term “advertisement component” is used to indicate an advertisement image, a decoration method for decorating the advertisement image, and a display position of the advertisement image relative to a material image. The advertisement image is a predetermined image that is set in advance, examples of which include a company logo, an event name, and a hashtag.

The storage unit 206 also stores an advertisement component selection rule table illustrated in FIG. 10. The advertisement component selection rule table is an example of rule information. The advertisement component selection rule table is a table for managing rules for a method for displaying an advertisement image in accordance with the additional component. Examples of the method for displaying an advertisement image include a decoration method for decorating the advertisement image, and a display position of the advertisement image. Specifically, the advertisement component selection rule table manages a combination of a message number and a motion, and an advertisement component in association with each other. An advertisement component with no motion specified matches any motion.

The advertisement component number is an example of identification information uniquely identifying an advertisement component, such as an identification number. The decoration method is a method for decorating an advertisement image. The display position indicates a position at which the advertisement image is to be displayed relative to a material image.

In the advertisement component selection rule table illustrated in FIG. 10, for example, the combination of the message number “1” and the motion “jump” is associated with “neon” as the decoration method for decorating the advertisement image with the advertisement component number “3” and “upper left corner” as the display position of the advertisement image. The message number “2” is associated with “monitor” as the decoration method for decorating the advertisement image with the advertisement component number “3” and “lower left corner” as the display position of the advertisement image, regardless of the motion.

While the message table, the advertisement component table, and the advertisement component selection rule table described above are information in a table format, these tables are not limited to the illustrated ones and may be information in any format that enables the values in the columns of each table to be managed in association with each other.

The acquisition unit 201, the input unit 202, the providing unit 203, the determination unit 204, and the generation unit 205 of the content providing server 20 illustrated in FIG. 7 may be implemented through execution of a program by the CPU 601 illustrated in FIG. 4, that is, by software, by hardware such as integrated circuits, or by a combination of software and hardware.

The functional units of the content providing server 20 illustrated in FIG. 7 are conceptually illustrated functions and are not limited to the illustrated components. For example, a plurality of functional units that are illustrated as independent functional units in FIG. 7 may be combined into one functional unit. Alternatively, a function of one of the functional units illustrated in FIG. 7 may be divided into a plurality of functions to form a plurality of functional units. For example, in the determination unit 204, a functional unit (first determination unit) that determines an additional component, and a functional unit (second determination unit) that determines an advertisement component may be represented as separate functional units.

### Process for Reading Sheet and Process for Extracting Title Image and the Like

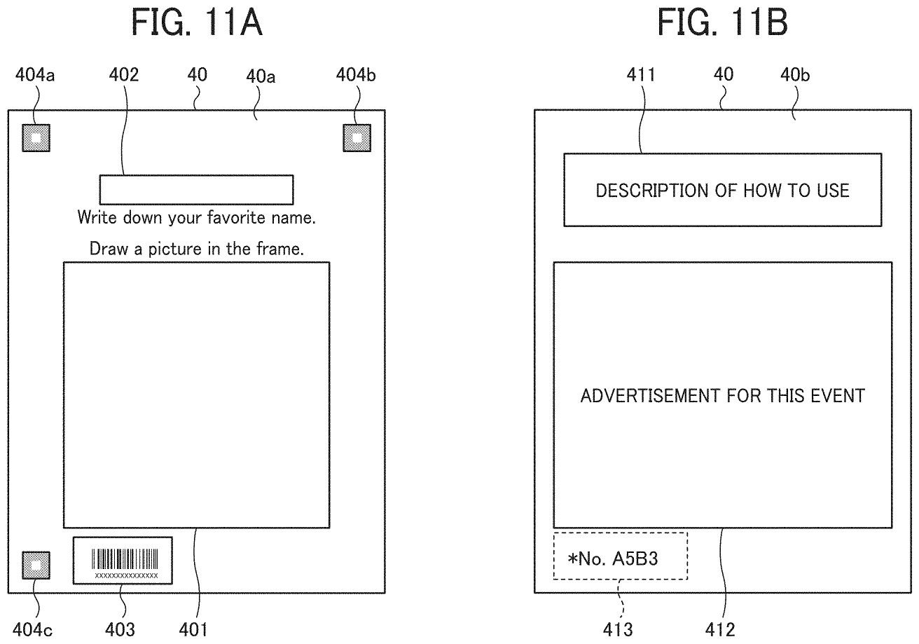

FIGS. 11A and 11B are views illustrating an example of a sheet for freehand drawing, which is used in an image display system according to an embodiment of the disclosure. FIG. 12 is a view illustrating an example of a picture drawn on the sheet for freehand drawing, which is used in the image display system according to an embodiment of the disclosure. A process for reading the sheet 40 and a process for extracting a title image and the like will be described with reference to FIGS. 11A, 11B, and 12.

As illustrated in FIG. 11A, the sheet 40 has a front side 40a on which a drawing area 401, a title area 402, and an identification code 403 are arranged. The drawing area 401 is an area in which a participant in the event draws a picture by hand. The title area 402 is an area in which the participant writes the title of the picture to be drawn. The identification code 403 includes identification information identifying the sheet 40. Further, markers 404a to 404c are arranged on the front side 40a at three corners among the four corners of the sheet 40. The markers 404a to 404c are markers for identifying the orientation and size of the sheet 40 and further identifying the positions and sizes of the drawing area 401, the title area 402, and the identification code 403. The positions of the drawing area 401, the title area 402, and the identification code 403 on the sheet 40 are determined in advance relative to the positions of the markers 404a to 404c. In FIG. 11A, a barcode is illustrated as the identification information of the identification code 403, for example, but not limitation. The identification code 403 may be, for example, a two-dimensional code such as a QR code (registered trademark) or a color code.

As illustrated in FIG. 11B, the sheet 40 has a back side 40b on which a description area 411, an event advertisement area 412, and an identification code 413 are arranged. The description area 411 includes a description of a web page use method for using the picture drawn on the front side 40a. The event advertisement area 412 is an area in which an announcement of the event, an advertisement, or the like appears. The identification code 413 indicates the same identification information as the identification code 403 in the form of numbers, alphabet letters, and symbols.

FIG. 12 illustrates an example of the sheet 40 on which a picture of an automobile is drawn in the drawing area 401 and the title of the picture, “Green Car”, is written in the title area 402. A participant may be allowed to directly draw a picture in the drawing area 401. Alternatively, for example, the outline of a certain picture may be drawn in the drawing area 401 to allow a participant to color in the picture, as desired, to complete the picture.

The image reading apparatus 12 reads the sheet 40 on which a picture is drawn in the drawing area 401 and the title of the picture is written in the title area 402 to obtain a read image. The image acquisition unit 111 of the display control apparatus 11 receives and acquires the read image from the image reading apparatus 12.

The extraction unit 112 of the display control apparatus 11 extracts, from the read image acquired by the image acquisition unit 111, a material image that is an image of the picture drawn in the drawing area 401, a title image that is an image of the title written in the title area 402, and the identification code 403. Specifically, the extraction unit 112 first performs, for example, pattern matching or the like to detect the markers 404a to 404c from the read image. The markers 404a to 404c are detected to identify the orientation and size of the sheet 40 and further identify the positions and sizes of portions corresponding to the drawing area 401, the title area 402, and the identification code 403 in the read image. Then, the extraction unit 112 binarizes an image portion corresponding to the drawing area 401 in the read image in accordance with whether each pixel in the image portion is white (the background color of the sheet 40) to extract the material image. The extraction unit 112 can also binarize the title image in the title area 402 in a similar manner to extract the title image. Further, the extraction unit 112 can extract a barcode from the identification code 403 and decode the barcode to obtain identification information of the sheet 40.

### Process for Registering Material Image in Content Providing Server

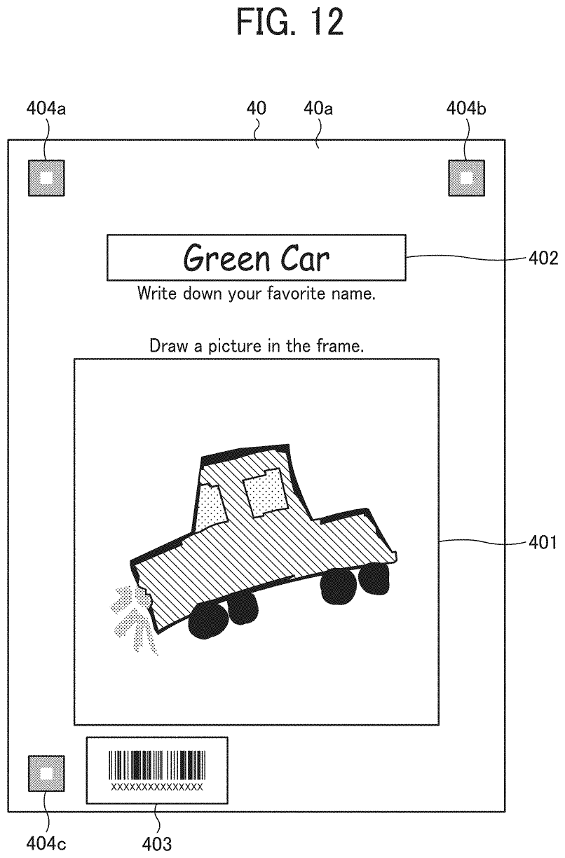

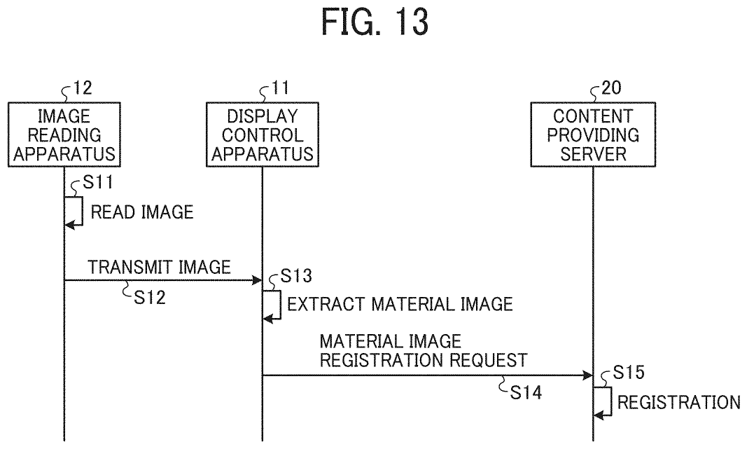

FIG. 13 is a sequence diagram illustrating an example process for registering, in a content providing server, a material image acquired by a display control apparatus in an information processing system according to an embodiment of the disclosure. A process for registering a material image and the like, which are acquired by the display control apparatus 11 in the information processing system 1 according to this embodiment, in the content providing server 20 will be described with reference to FIG. 13.

### Step S11

In the event venue, the operator receives a sheet 40 with a picture drawn by a participant in the event, sets the sheet 40 in the image reading apparatus 12, and presses an image reading start button, for example. The image reading apparatus 12 reads the sheet 40 on which the picture is drawn in the drawing area 401 and the title of the picture is written in the title area 402 to obtain a read image.

### Step S12

The image reading apparatus 12 transmits the read image obtained by the reading process performed on the sheet 40 to the display control apparatus 11. The image acquisition unit 111 of the display control apparatus 11 receives and acquires the read image from the image reading apparatus 12.

### Step S13

The extraction unit 112 of the display control apparatus 11 extracts a material image that is an image of the picture drawn in the drawing area 401, a title image that is an image of the title written in the title area 402, and the identification code 403 from the read image by using the method described above.

### Step S14

The extraction unit 112 constructs management information from a predetermined store code and identification information decoded from the extracted identification code 403, and transmits, to the content providing server 20, a registration request for registering the material image and the title image in a storage location such as a path indicated by the management information.

### Step S15

The acquisition unit 201 of the content providing server 20 receives and acquires the management information, the material image, the title image, and the registration request for registering the material image and the title image. Then, the acquisition unit 201 registers the material image and the title image in a storage location such as a path in the storage unit 206 indicated by the management information in association with the identification information included in the management information.

In the process illustrated in FIG. 13, an image read from each sheet 40 is output to the display control apparatus 11 from the image reading apparatus 12. The display control apparatus 11 repeatedly issues a registration request each time an image read from the sheet 40 is received. However, some or all of the steps for the registration request may be collectively performed on a plurality of read images in response to a certain number of read images being accumulated or at intervals of a predetermined time, for example.

As described above, the operator presses the image reading start button to start image reading each time a sheet 40 on which a picture is drawn by a participant in the event is set in the image reading apparatus 12. However, embodiments of the present disclosure are not limited to this. For example, when the image reading apparatus 12 has an auto document feeder (ADF), a plurality of sheets 40 may be set, and the image reading start button may be pressed once to continuously read images from the sheets 40.

### Modified-Image Generation Process

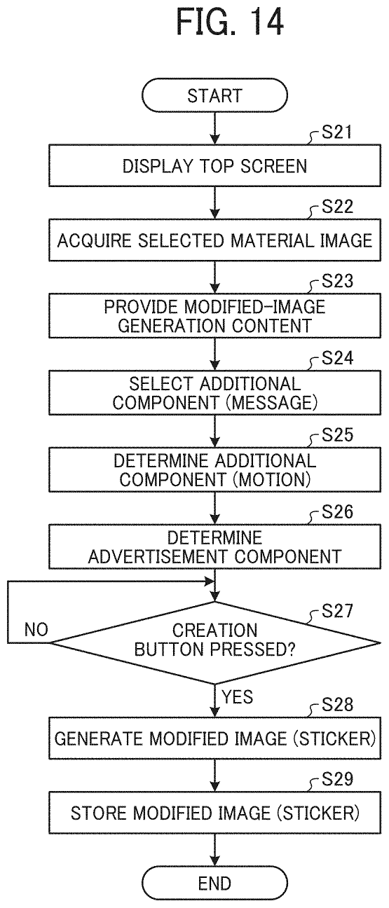

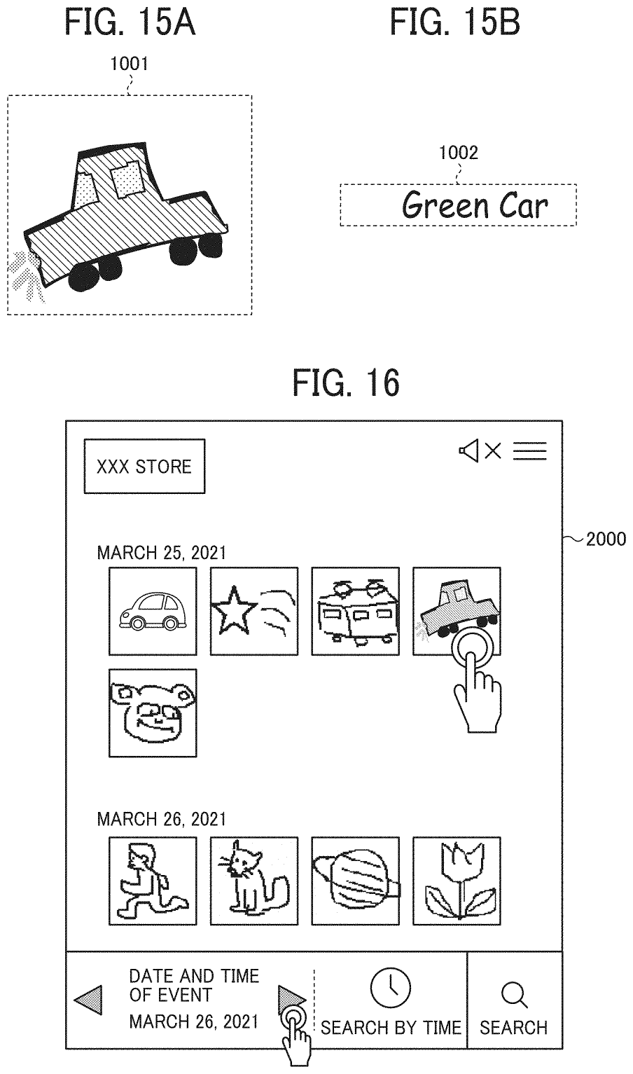

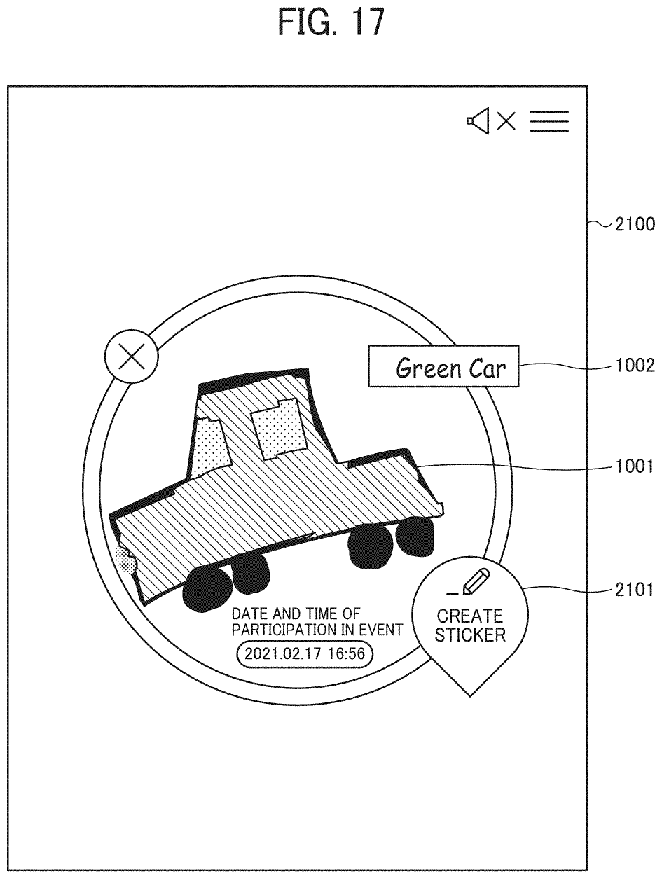

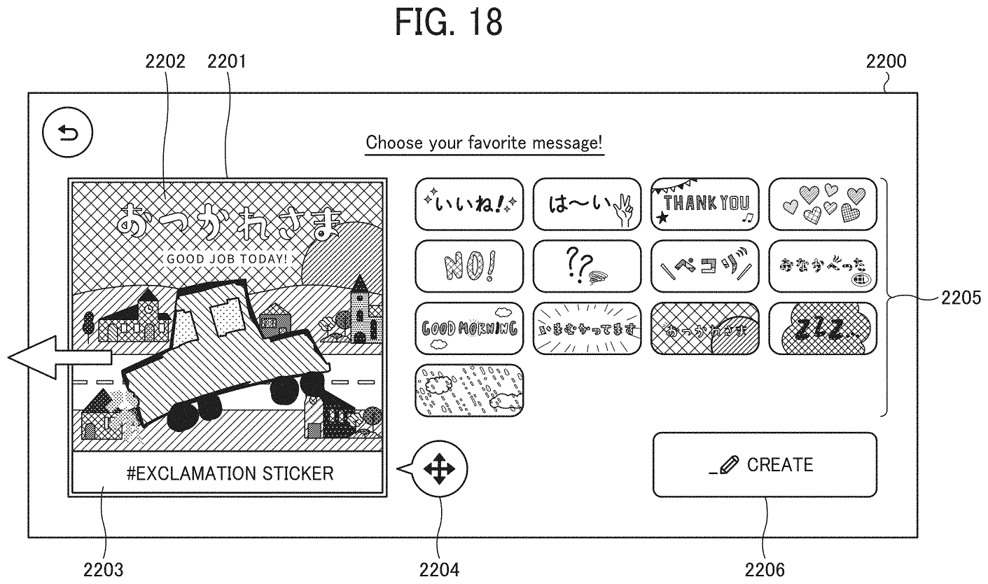

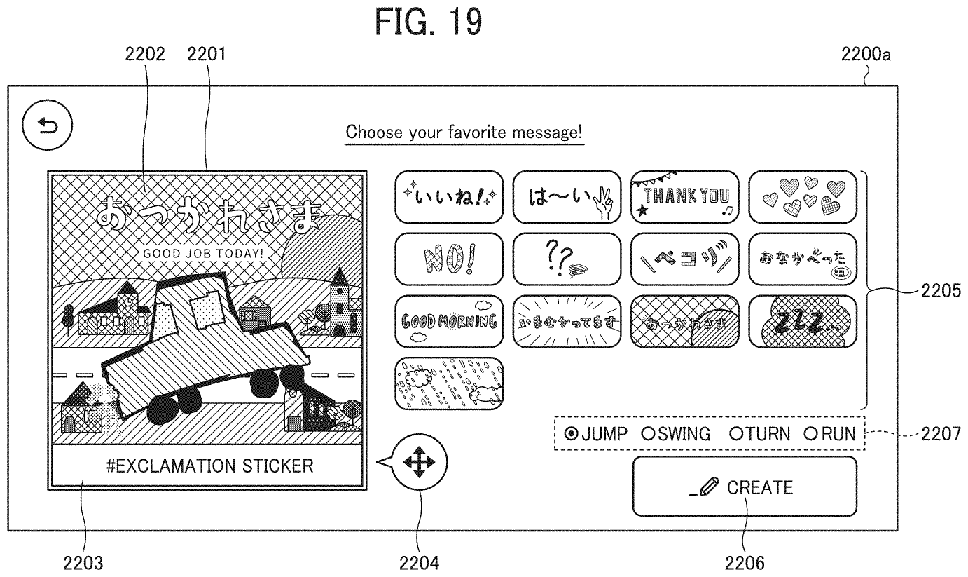

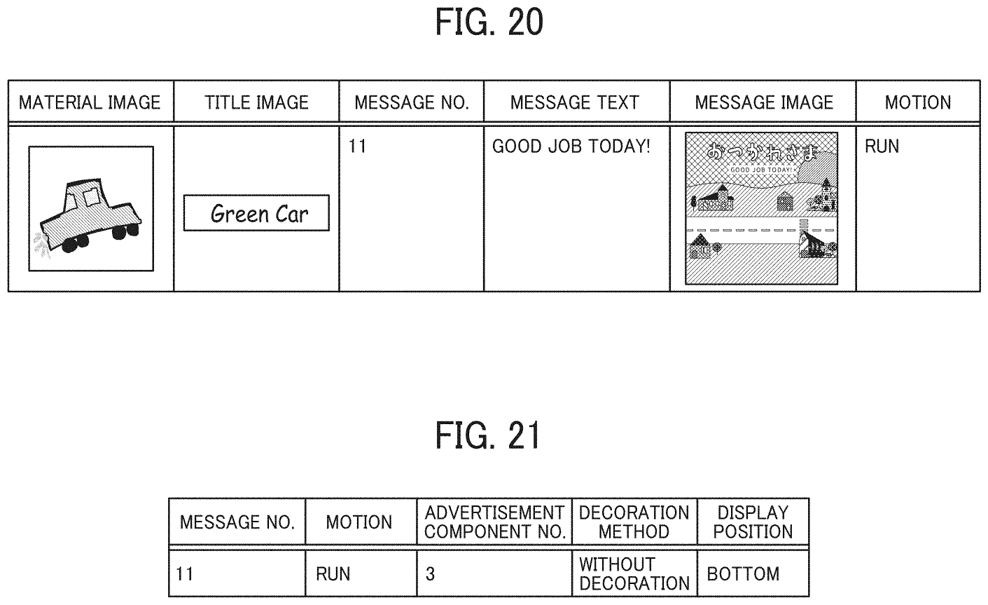

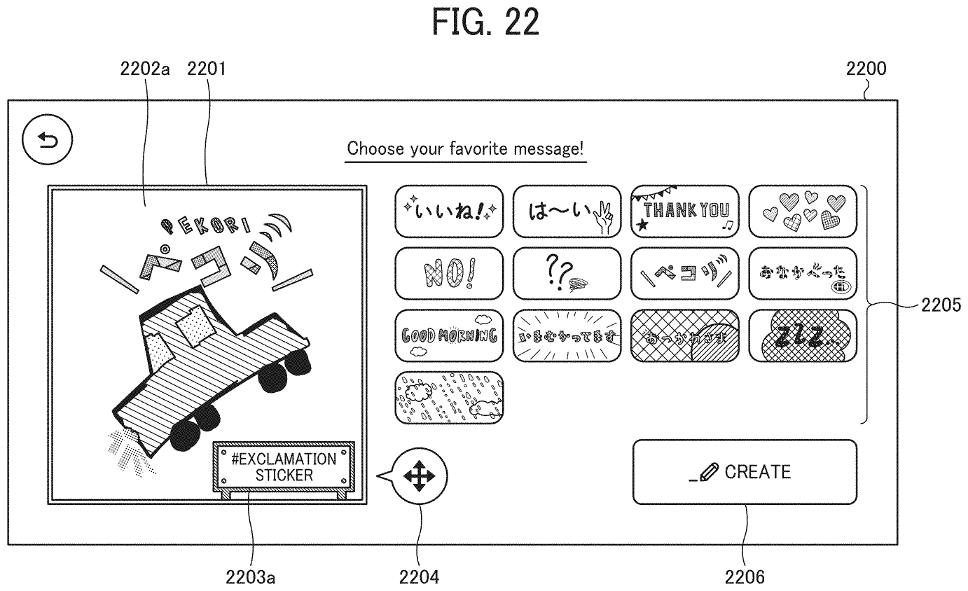

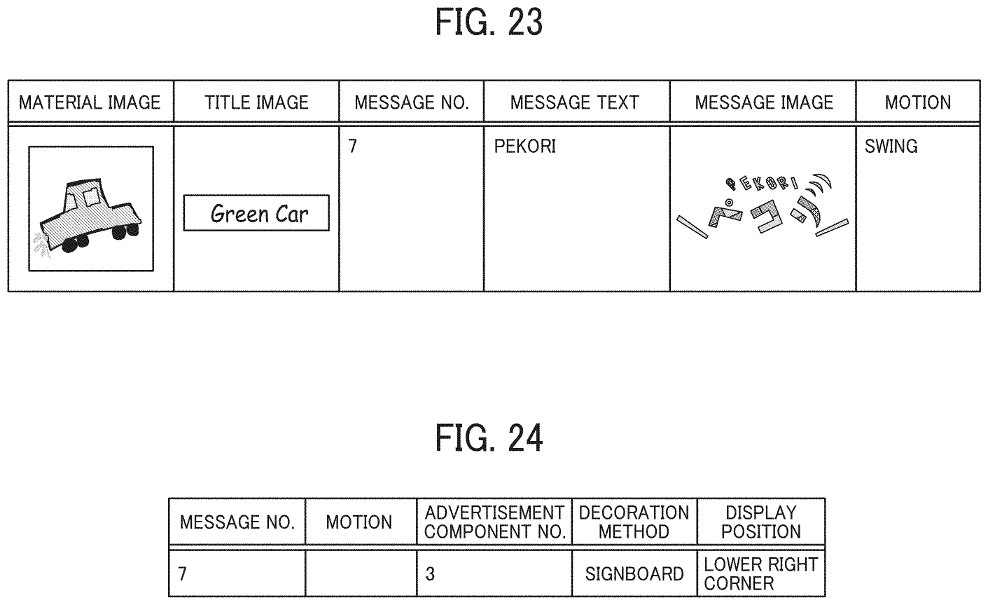

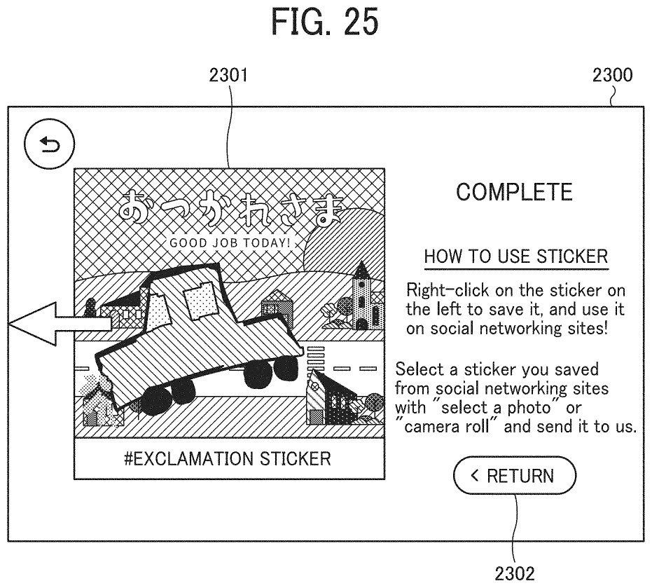

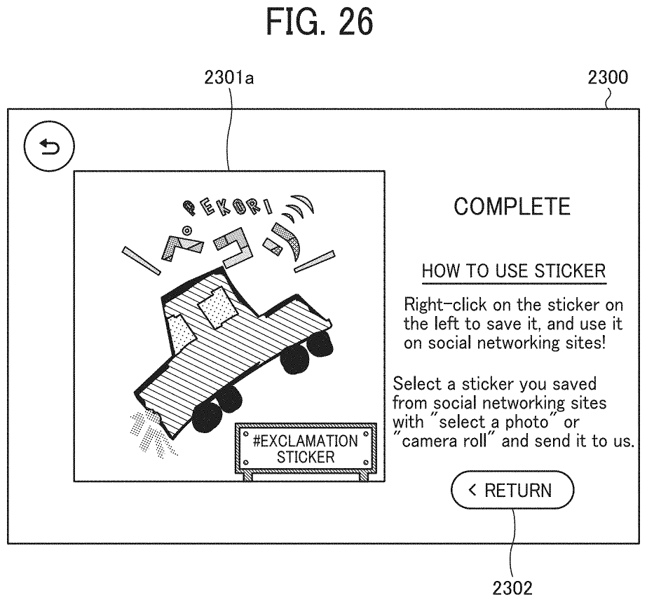

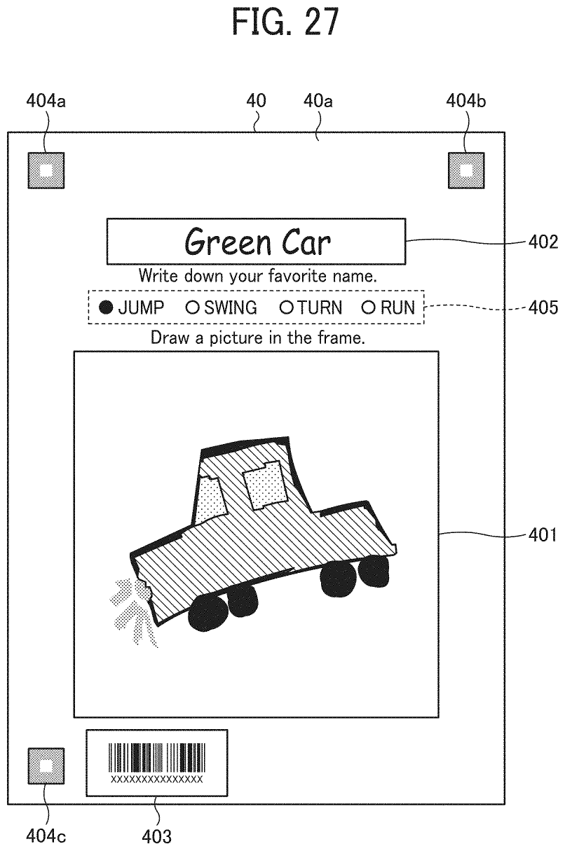

FIG. 14 is a flowchart illustrating an example modified-image generation process performed by a content providing server according to an embodiment of the disclosure. FIGS. 15A and 15B are views illustrating an example of a material image and a title image, respectively. FIG. 16 is a view illustrating an example of a top screen for selecting a material image. FIG. 17 is a view illustrating an example of a material display screen. FIG. 18 is a view illustrating an example of selection of a message on a message selection screen. FIG. 19 is a view illustrating an example of a message selection screen on which a motion is selectable. FIG. 20 is a view illustrating an example of results of an association between a material image and a message. FIG. 21 is a view illustrating an example of a determined advertisement component. FIG. 22 is a view illustrating another example of selection of a message on the message selection screen. FIG. 23 is a view illustrating another example of results of an association between a material image and a message. FIG. 24 is a view illustrating another example of the determined advertisement component. FIG. 25 is a view illustrating an example of a modified-image completion screen. FIG. 26 is a view illustrating another example of the modified-image completion screen. A modified-image generation process performed by the content providing server 20 according to this embodiment will be described with reference to FIGS. 14 to 26. It is assumed that a participant in the event who has the information terminal 30 draws a picture and writes a title on the sheet 40 in the event, the sheet 40 is read by the image reading apparatus 12, and a material image 1001 of the picture and a title image 1002 of the title of the picture, as illustrated in FIGS. 15A and 15B, respectively, which are extracted from the sheet 40, are registered in the content providing server 20.

### Step S21

First, the web browser of the information terminal 30 is activated in response to an operation performed by the participant in the event, and the information terminal 30 transmits a command for activating a predetermined web application to the content providing server 20. Then, the providing unit 203 of the content providing server 20 transmits a web page of a top screen 2000 of the web application illustrated in FIG. 16 to the information terminal 30, and the information terminal 30 causes the display 718 to display the top screen 2000. Then, the process proceeds to step S22.

### Step S22

As illustrated in FIG. 16, the top screen 2000 displayed on the display 718 of the information terminal 30 displays, for example, a list of thumbnails of material images registered in the content providing server 20. The participant selects a desired material image from among the material images displayed as thumbnails on the top screen 2000 via the touch panel 721. Then, the acquisition unit 201 of the content providing server 20 acquires, from the storage unit 206, the material image 1001 and the title image 1002 corresponding to the thumbnail of the material image selected with the information terminal 30.

Then, the providing unit 203 transmits a web page of a material display screen 2100 illustrated in FIG. 17, which displays the material image 1001 and the title image 1002 acquired by the acquisition unit 201, to the information terminal 30, and the information terminal 30 causes the display 718 to display the material display screen 2100. As illustrated in FIG. 17, the material display screen 2100 includes the material image 1001, the title image 1002, and a creation start button 2101. The creation start button 2101 is a button for adding an additional component and an advertisement component to the material image 1001 to create a modified image such as a sticker.

The top screen 2000 illustrated in FIG. 16 displays a list of thumbnails of material images registered in the content providing server 20. However, embodiments of the present disclosure are not limited to this. For example, the participant may enter the identification code 413, which is displayed on the back side 40b of the sheet 40 used in the event, on a web page displayed on the information terminal 30 such that the acquisition unit 201 acquires the material image 1001 and the title image 1002 identified by the identification information indicated by the identification code 413 from the storage unit 206. As a result, the providing unit 203 can directly display, on the information terminal 30, the web page of the material display screen 2100 illustrated in FIG. 17, which displays the material image 1001 and the title image 1002 acquired by the acquisition unit 201.

The thumbnails of the material images displayed in list view on the top screen 2000 may be displayed by store or date and time in or at which the event was held.

Then, the process proceeds to S23.

### Step S23

In response to the participant touching the creation start button 2101 on the material display screen 2100, the providing unit 203 of the content providing server 20 provides (or transmits), to the information terminal 30, a web page of a message selection screen 2200 illustrated in FIG. 18 or 22. The message selection screen 2200 is modified-image generation content for adding an additional component for imparting a message and a motion and an advertisement component to the material image 1001. Then, the information terminal 30 causes the display 718 to display the message selection screen 2200.

The message selection screens 2200 illustrated in FIGS. 18 and 22 are each a screen for adding an additional component for imparting a message and a motion, and an advertisement component to the material image 1001. As illustrated in FIGS. 18 and 22, each of the message selection screens 2200 includes a modified image display area 2201, an adjustment button 2204, message buttons 2205, and a creation button 2206.

The modified image display area 2201 is an area for displaying a modified image generated by adding an additional component selected using any one of the message buttons 2205 and an advertisement image corresponding to the additional component to the material image 1001. The adjustment button 2204 is a button for adjusting the position of the material image 1001 displayed in the modified image display area 2201. The message buttons 2205 are buttons used to select a message among additional components to be addable to the material image 1001. Each of the message buttons 2205 displays a message to be added to the material image 1001. The creation button 2206 is a button for generating a modified image using an additional component selected using one of the message buttons 2205 and an advertisement component corresponding to the additional component.

Then, the process proceeds to S24.

### Step S24

The participant selects a message button 2205 designating a message that the participant desires to add to the material image 1001 among the message buttons 2205 that display various messages. Then, the process proceeds to S25.

### Step S25

The determination unit 204 of the content providing server 20 refers to the message table illustrated in FIG. 8, extracts a message number, a message text, a message image, and a motion in the additional component corresponding to the message button 2205 selected by the participant, and associates the extracted message number, message text, message image, and motion with the material image 1001 and the title image 1002. Accordingly, the determination unit 204 (first determination unit) determines an additional component corresponding to the material image 1001 and the title image 1002. That is, the motion is determined together with the message (the message text and the message image), as the additional component.

For example, in the example of the message selection screen 2200 illustrated in FIG. 18, a message button 2205 that displays the text “GOOD JOB TODAY!” is selected. In this case, the determination unit 204 refers to the message table, extracts an additional component corresponding to the selected message button 2205, namely, the message number “11”, the message text “GOOD JOB TODAY!”, the message image, and the motion “run”, and associates the extracted information with the material image 1001 and the title image 1002, as illustrated in FIG. 20. As a result, the determination unit 204 determines the message text “GOOD JOB TODAY!”, the message image illustrated in FIG. 20, and the motion “run” as the additional component corresponding to the material image 1001 and the title image 1002.

For example, in the example of the message selection screen 2200 illustrated in FIG. 22, a message button 2205 that displays the text “PEKORI (meaning bobbing his/her head)” is selected. In this case, the determination unit 204 refers to the message table, extracts an additional component corresponding to the selected message button 2205, namely, the message number “7”, the message text “PEKORI”, the message image, and the motion “swing”, and associates the extracted information with the material image 1001 and the title image 1002, as illustrated in FIG. 23. As a result, the determination unit 204 determines the message text “PEKORI”, the message image illustrated in FIG. 23, and the motion “swing” as the additional component corresponding to the material image 1001 and the title image 1002.

While a motion in an additional component is associated with each message in the message table in advance, embodiments of the present disclosure are not limited to this. For example, as in a message selection screen 2200a illustrated in FIG. 19, motion selection radio buttons 2207 may be included in addition to the modified image display area 2201, the message buttons 2205, and the creation button 2206. Accordingly, one of the message buttons 2205 may be selected to designate a message to be added to the material image 1001, and, in addition, one of the motion selection radio buttons 2207 may be selected to designate a motion to be imparted to the material image 1001. As a result, a motion desired by the user (or participant) may be added to a material image to generate a modified image.

Then, the process proceeds to S26.

### Step S26

The determination unit 204 refers to the advertisement component selection rule table illustrated in FIG. 10 and extracts an advertisement component number, a decoration method, and a display position in the advertisement component corresponding to the additional component (here, the message number and the motion) determined in step S25. The determination unit 204 further refers to the advertisement component table illustrated in FIG. 9 and extracts an advertisement image corresponding to the extracted advertisement component number. Accordingly, the determination unit 204 (second determination unit) determines an advertisement component (an advertisement image, a decoration method, and a display position) corresponding to the additional component for the material image 1001. That is, the determination unit 204 determines an advertisement image corresponding to the additional component for the material image 1001 and a display method (a decoration method and a display position) of the advertisement image. Then, the generation unit 205 of the content providing server 20 adds the additional component and the advertisement component determined by the determination unit 204 to the material image 1001 to temporarily generate a modified image, and displays the generated modified image in the modified image display area 2201 of the message selection screen 2200. As a result, the participant is able to check, based on the selected message, how the additional component is to be added to the material image and how the advertisement image is displayed in what position and by what decoration method.

The following describes, for example, an operation to be performed in response to, as in the example of the message selection screen 2200 illustrated in FIG. 18, selection of the message button 2205 displaying the text “GOOD JOB TODAY!”. In this case, as illustrated in FIG. 21, the determination unit 204 refers to the advertisement component selection rule table and extracts an advertisement component corresponding to the message number “11” and the motion “run” illustrated in FIG. 20, namely, the advertisement component number “3”, the decoration method “without decoration”, and the display position “bottom”. The determination unit 204 further refers to the advertisement component table and extracts the advertisement image “#exclamation sticker” corresponding to the advertisement component number “3”. As a result, the determination unit 204 determines the advertisement image “#exclamation sticker”, the decoration method “without decoration”, and the display position “bottom” as the advertisement component corresponding to the additional component for the material image 1001. Then, as illustrated in FIG. 18, the generation unit 205 adds the message image and the motion “run” as the additional component determined by the determination unit 204 to the material image 1001 and adds the advertisement image “#exclamation sticker” to the material image 1001 in the form of the decoration method “without decoration” and the display position “bottom” to temporarily generate a modified image to display the modified image in the modified image display area 2201. In the modified image display area 2201 illustrated in FIG. 18, an image obtained by adding the message image and the motion “run” to the material image 1001 is displayed as a message-added image 2202, and the advertisement image “#exclamation sticker” added to the material image 1001 in the form of the decoration method “without decoration” and the display position “bottom” is displayed as an advertisement image 2203. As illustrated in FIG. 18, since the motion “run” is imparted to the car in the material image 1001 as the additional component, the generation unit 205 generates a modified image in the form of a GIF animation such that, for example, the car in the material image 1001 is moving from right to left in a direction indicated by an arrow illustrated in FIG. 18.

The following describes, for example, an operation to be performed in response to, as in the example of the message selection screen 2200 illustrated in FIG. 22, selection of the message button 2205 displaying the text “PEKORI”. In this case, as illustrated in FIG. 24, the determination unit 204 refers to the advertisement component selection rule table and extracts an advertisement component corresponding to the message number “7” and the motion “swing” illustrated in FIG. 23, namely, the advertisement component number “3”, the decoration method “signboard”, and the display position “lower right corner”. The determination unit 204 further refers to the advertisement component table and extracts the advertisement image “#exclamation sticker” corresponding to the advertisement component number “3”. As a result, the determination unit 204 determines the advertisement image “#exclamation sticker”, the decoration method “signboard”, and the display position “lower right corner” as the advertisement component corresponding to the additional component for the material image 1001. Then, as illustrated in FIG. 22, the generation unit 205 adds the message image and the motion “swing” as the additional component determined by the determination unit 204 to the material image 1001 and adds the advertisement image “#exclamation sticker” to the material image 1001 in the form of the decoration method “signboard” and the display position “lower right corner” to temporarily generate a modified image to display the modified image in the modified image display area 2201. In the modified image display area 2201 illustrated in FIG. 22, an image obtained by adding the message image and the motion “swing” to the material image 1001 is displayed as a message-added image 2202a, and the advertisement image “#exclamation sticker” added to the material image 1001 in the form of the decoration method “signboard” and the display position “lower right corner” is displayed as an advertisement image 2203a. As illustrated in FIG. 22, since the motion “swing” is imparted to the car in the material image 1001 as the additional component, the generation unit 205 generates a modified image in the form of a GIF animation such that, for example, the car in the material image 1001 is swinging (bobbing its head).

Then, the process proceeds to step S27.

### Step S27

If the creation button 2206 on the message selection screen 2200 illustrated in FIG. 18 or 22 is pressed (touched) (step S27: Yes), the process proceeds to step S28. If the creation button 2206 is not pressed (step S27: No), the process stands by. If the creation button 2206 is not pressed, the process may return to step S24 and any other message button 2205 may be selected.

### Step S28

The generation unit 205 adds the additional component and the advertisement component determined by the determination unit 204 to the material image 1001 to generate a modified image. That is, the generation unit 205 generates a modified image such that the additional component is added to the material image 1001 and the advertisement image determined by the determination unit 204 is displayed in accordance with the determined display method (the decoration method and the display position). Then, the process proceeds to step S29.

### Step S29

The generation unit 205 stores the generated modified image in the storage unit 206 in association with, for example, the material image 1001. Then, the providing unit 203 provides (transmits) a web page of a modified-image completion screen 2300 illustrated in FIG. 25 or 26, which displays the modified image generated by the generation unit 205, to the information terminal 30. Then, the information terminal 30 causes the display 718 to display the modified-image completion screen 2300. In this case, the providing unit 203 may store the modified image in the EEPROM 704 of the information terminal 30. As a result, the participant is able to use the modified image stored in the EEPROM 704 as a sticker image or the like in the SNS.

For example, in response to pressing of the creation button 2206 on the message selection screen 2200 illustrated in FIG. 18, the providing unit 203 displays a modified image generated by the generation unit 205 as a modified image 2301 illustrated in FIG. 25, and then provides (transmits) a web page of the modified-image completion screen 2300 including a return button 2302 to the information terminal 30. As in the modified image 2301 illustrated in FIG. 25, when the message to be added to the material image 1001 includes a colorful image, a complex-pattern image, or the like, a simple advertisement image is selected as the advertisement image to be displayed. As a result, an advertisement can be added to the material image 1001, which is image data, in a display manner that is visually balanced with the additional component. Pressing the return button 2302 enables the user (or participant) to again select a message on the message selection screen 2200 to generate a different modified image.

In response to pressing of the creation button 2206 on the message selection screen 2200 illustrated in FIG. 22, the providing unit 203 displays a modified image generated by the generation unit 205 as a modified image 2301a illustrated in FIG. 26, and then provides (transmits) a web page of the modified-image completion screen 2300 including a return button 2302 to the information terminal 30. As in the modified image 2301 illustrated in FIG. 26, when the message to be added to the material image 1001 includes a simple image (e.g., an image with a background of white or a single color), an image that is conspicuous to a certain extent, such as in a signboard form, is selected as the advertisement image to be displayed. As a result, an advertisement can be added to the material image 1001, which is image data, in a display manner that is visually balanced with the additional component. Pressing the return button 2302 enables the user (or participant) to again select a message on the message selection screen 2200 to generate a different modified image.

Through the processing of steps S21 to S29 described above, the content providing server 20 executes the modified-image generation process.

As described above, in the content providing server 20 according to this embodiment, the determination unit 204 determines an additional component to be added to a material image drawn on the sheet 40 serving as a medium, and determines an advertisement component in accordance with the additional component, and the generation unit 205 adds the additional component and the advertisement component to the material image to generate a modified image. More specifically, the determination unit 204 determines, as an advertisement component, an advertisement image and a display method for the advertisement image in accordance with the additional component, and the generation unit 205 generates a modified image such that the additional component is added to a material image and the advertisement image is displayed in accordance with the display method. As a result, an advertisement can be added to the material image 1001, which is image data, in a display manner that is visually balanced with the additional component. In addition, effective advertisement can be performed using a modified image such as a sticker.

The generation unit 205 adds an additional component and an advertisement component determined by the determination unit 204 to a material image to generate a modified image, by way of example but not limitation. The generation unit 205 may generate a modified image additionally including a title image.

Further, the determination unit 204 refers to the advertisement component selection rule table and determines an advertisement component in accordance with an additional component that has been determined, by way of example but not limitation. For example, the determination unit 204 may determine an advertisement component in accordance with a feature of a message in the additional component. Alternatively, the determination unit 204 may determine an advertisement component in accordance with a motion in the additional component. Alternatively, the determination unit 204 may analyze the material image 1001 in addition to the additional component and determine an advertisement component in accordance with the analysis result. The analysis result may include, for example, a predetermined feature value obtained by analysis of the material image 1001.

### Modifications

FIG. 27 is a view illustrating an example of a picture drawn on a sheet for freehand drawing, which is used in an image display system according to a modification. The image display system 10 according to the embodiment described above is configured to determine a motion for a material image in accordance with a message selected on the message selection screen 2200. An image display system 10 according to this modification will be described with reference to FIG. 27, with a focus on differences from the image display system 10 according to the embodiment described above.

As illustrated in FIG. 27, the sheet 40 has a front side 40a on which a drawing area 401, a title area 402, an identification code 403, and a motion selection area 405 are arranged. The drawing area 401 is an area in which a participant in the event draws a picture by hand. The title area 402 is an area in which the participant writes the title of the picture to be drawn. The identification code 403 includes identification information identifying the sheet 40. The motion selection area 405 is an area for selecting a motion to be imparted to the picture. Further, markers 404a to 404c are arranged on the front side 40a at three corners among the four corners of the sheet 40.

The image reading apparatus 12 reads the sheet 40 on which a picture is drawn in the drawing area 401, on which the title of the picture is written in the title area 402, and on which a desired motion is selected in the motion selection area 405 to obtain a read image. The image acquisition unit 111 of the display control apparatus 11 receives and acquires the read image from the image reading apparatus 12.

The extraction unit 112 of the display control apparatus 11 extracts, from the read image acquired by the image acquisition unit 111, a material image that is an image of the picture drawn in the drawing area 401, a title image that is an image of the title written in the title area 402, the identification code 403, and an image portion of the motion selection area 405. Specifically, the extraction unit 112 first performs, for example, pattern matching or the like to detect the markers 404a to 404c from the read image. The markers 404a to 404c are detected to identify the orientation and size of the sheet 40 and further identify the positions and sizes of portions corresponding to the drawing area 401, the title area 402, the identification code 403, and the motion selection area 405 in the read image. Then, the extraction unit 112 binarizes an image portion corresponding to the drawing area 401 in the read image in accordance with whether each pixel in the image portion is white (the background color of the sheet 40) to extract the material image. The extraction unit 112 can also binarize the title image in the title area 402 in a similar manner to extract the title image. Further, the extraction unit 112 can extract a barcode from the identification code 403 and decode the barcode to obtain identification information of the sheet 40. Further, the extraction unit 112 extracts an image portion of the motion selection area 405 in a similar manner and further determines which motion is selected from the image portion.

The extraction unit 112 constructs management information from a predetermined store code and identification information decoded from the extracted identification code 403, and transmits, to the content providing server 20, a registration request for registering the material image, the title image, and the selected motion in a storage location such as a path indicated by the management information. The acquisition unit 201 of the content providing server 20 receives and acquires the management information, the material image, the title image, the selected motion, and the registration request for registering the material image, the title image, and the selected motion. Then, the acquisition unit 201 registers the material image, the title image, and the selected motion in a storage location such as a path in the storage unit 206 indicated by the management information in association with the identification information included in the management information.

After the event, the participant selects a desired material image from among the material images displayed as thumbnails on the top screen 2000 displayed on the information terminal 30 via the touch panel 721. Then, the acquisition unit 201 of the content providing server 20 acquires, from the storage unit 206, the material image 1001, the title image 1002, and the motion corresponding to the thumbnail of the material image selected with the information terminal 30. The subsequent operation of displaying the material display screen 2100 and the message selection screen 2200 is similar to that in the embodiment described above.

The participant selects a message button 2205 designating a message that the participant desires to add to the material image 1001 among the message buttons 2205 that display various messages. The determination unit 204 of the content providing server 20 refers to the message table, extracts a message number, a message text, and a message image in the additional component corresponding to the message button 2205 selected by the participant, and associates the extracted message number, message text, and message image with the material image 1001, the title image 1002, and the motion. As a result, the determination unit 204 determines an additional component corresponding to the material image 1001 and the title image 1002. The subsequent operation is similar to that in the embodiment described above.

With the configuration described above, when a picture from which a material image is generated is drawn on the sheet 40 in an event, a motion to be imparted to the picture may be selected, and a motion desired by the user (or participant) may be added to the material image to generate a modified image.

Each of the functions in the embodiment and the modification described above may be implemented by one or more processing circuits or circuitry. The term “processing circuit” or “processing circuitry” used herein includes a processor programmed to implement each function by software, such as a processor implemented by an electronic circuit, and devices designed to implement the functions described above, such as an application specific integrated circuit (ASIC), a digital signal processor (DSP), a field programmable gate array (FPGA), and existing circuit modules.

In addition, programs to be executed by the display control apparatus 11, the content providing server 20, and the information terminal 30 according to the embodiment and the modification described above may be configured to be pre-installed in a ROM or the like and provided.

The programs to be executed by the display control apparatus 11, the content providing servers 20, and the information terminals 30 according to the embodiment and the modification described above may be configured to be recorded in any computer-readable recording medium, such as a compact disc read only memory (CD-ROM), a flexible disk (FD), a CD-R, or a DVD, in an installable or executable file format and provided as a computer program product.

In addition, the programs to be executed by the display control apparatus 11, the content providing server 20, and the information terminal 30 according to the embodiment and the modification described above may be configured to be stored in a computer connected to a network such as the Internet and provided by being downloaded via the network. In addition, the programs to be executed by the display control apparatus 11, the content providing server 20, and the information terminal 30 according to the embodiment and the modification described above may be configured to be provided or distributed via a network such as the Internet.

In addition, the programs to be executed by the display control apparatus 11, the content providing server 20, and the information terminal 30 according to the embodiment and the modification described above have module configurations including the functional units described above. In actual hardware, a CPU (or processor) reads the programs from the ROM and executes the read programs to load the functional units described above onto a main storage device and generate the functional units on the main storage device.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An information processing system comprising:
circuitry configured to:
determine an additional component to be added to a material image drawn on a medium;
determine an advertisement component according to the additional component; and
add the additional component and the advertisement component to the material image to generate a modified image.

2. The information processing system according to claim 1,
wherein the circuitry is configured to:
determine an advertisement image as the advertisement component and a display method of the advertisement image, according to the additional component; and
generate the modified image, such that the advertisement image is displayed according to the display method.

3. The information processing system according to claim 2,
wherein the circuitry is configured to determine the advertisement image and the display method of the advertisement image, based on rule information for managing a rule for the display method of the advertisement image corresponding to the additional component.

4. The information processing system according to claim 2,
wherein the display method defines a decoration method for the advertisement image, and a display position of the advertisement image relative to the material image.

5. The information processing system according to claim 2,
wherein the advertisement image includes at least one of a logo, an event name, or a hashtag.

6. The information processing system according to claim 1,
wherein the circuitry is configured to determine an additional component selected from among a plurality of additional components to be addable to the material image, in response to a selection operation with an information terminal.

7. The information processing system according to claim 6,
wherein the circuitry is configured to transmit the generated modified image to the information terminal.

8. The information processing system according to claim 1,
wherein the additional component includes a message and a motion to be imparted to the material image.

9. The information processing system according to claim 8,
wherein the circuitry is configured to determine the advertisement component further according to a feature of the message.

10. The information processing system according to claim 1,
wherein the circuitry is configured to analyze the material image and determine the advertisement component further according to an analysis result.

11. The information processing system according to claim 1,
wherein the additional component includes a sound.

12. An information processing apparatus comprising:
circuitry configured to:
determine an additional component to be added to a material image drawn on a medium;
determine an advertisement component according to the additional component; and
add the additional component and the advertisement component to the material image to generate a modified image.

13. A method of processing information, comprising:
determining an additional component to be added to a material image drawn on a medium;
determining an advertisement component according to the additional component; and
adding the additional component and the advertisement component to the material image to generate a modified image.
